(19) United States
(12) Patent Application Publication
(10) Pub. No.: US 2025/0282201 A1
(43) Pub. Date: Sep. 11, 2025

(54) THERMAL MANAGEMENT APPARATUS AND THERMAL MANAGEMENT SYSTEM INCLUDING THE SAME

(71) Applicant: BorgWarner Inc., Auburn Hills, MI (US)

(72) Inventors: James Christopher Sharpe, South Lyon, MI (US); Cody Joseph Paupert, Oxford, MI (US); Stephen Michael Bohan, Davisburg, MI (US); Iago González Tabarés, Vigo (ES)

(21) Appl. No.: 19/072,383

(22) Filed: Mar. 6, 2025

Related U.S. Application Data
(60) Provisional application No. 63/562,771, filed on Mar. 8, 2024.

(51) Int. Cl. B60H 1/00; B60H 1/22

(52) U.S. Cl. CPC B60H 1/00885; B60H 1/00342; B60H 1/2215; B60H 1/00385

(57) ABSTRACT

A thermal management apparatus includes a manifold defining a first manifold flow path for directing a first working fluid and a second manifold flow path for directing a second working fluid, a first heating element in thermal communication with the first manifold flow path for heating the first working fluid, a second heating element operable independent of the first heating element and in thermal communication with the second manifold flow path for heating the second working fluid, and a heat exchanger defining a first heat exchanger flow path in fluid communication with the first manifold flow path and a second heat exchanger flow path in fluid communication with the second manifold flow path. The first heat exchanger flow path and the second heat exchanger flow path are disposed in thermal communication with each other to facilitate heat transfer between the first working fluid and the second working fluid.

### CROSS-REFERENCE TO RELATED APPLICATIONS

The present application claims priority to and all the benefits of U.S. Provisional Patent Application No. 63/562,771, filed Mar. 8, 2024.

### TECHNICAL FIELD

The present disclosure relates generally to thermal management apparatuses thermal management systems, and methods of operating thermal management systems for hybrid and electric vehicles.

### BACKGROUND

Hybrid and electric vehicles have distinct thermal management requirements compared to conventional internal combustion engine vehicles. Particularly, neither hybrid nor electric vehicles have an “always-on” internal combustion engine which constantly supplies heat energy for thermal management purposes. Furthermore, optimal performance, durability, and safety of key components of hybrid and electric vehicles, such as batteries and electric motors, are dependent on operating temperatures. Current thermal management systems for hybrids and electric vehicles typically utilize electric heaters to heat working fluids (such as coolant) to assist with thermal management operations such as heating the passenger cabin, regulating battery temperature, etc. However, these thermal management systems often lack the capability to independently control the temperature of multiple fluids, or require an undesirable number of components to do so. To this end, there remains a need for improved thermal management components and systems for hybrid and electric vehicles.

### SUMMARY AND ADVANTAGES

One general aspect of the present disclosure is directed to a thermal management apparatus. The thermal management apparatus includes a manifold defining a first manifold flow path and a second manifold flow path. The first manifold flow path is configured to direct a first working fluid. The second manifold flow path is configured to direct a second working fluid. The second manifold flow path is not in fluid communication with the first manifold flow path. The thermal management apparatus also includes a first heating element operatively attached to the manifold and in thermal communication with the first manifold flow path. The first heating element is configured to generate heat in response to being energized to heat the first working fluid as the first working fluid flows through the first manifold flow path. The thermal management apparatus also includes a second heating element operatively attached to the manifold and in thermal communication with the second manifold flow path. The second heating element is configured to generate heat in response to being energized to heat the second working fluid as the second working fluid flows through the second manifold flow path. The second heating element is operable independent of the first heating element. The thermal management apparatus further includes a heat exchanger operatively attached to the manifold. The heat exchanger defines a first heat exchanger flow path in fluid communication with the first manifold flow path, and a second heat exchanger flow path in fluid communication with the second manifold flow path. The first heat exchanger flow path and the second heat exchanger flow path are disposed in thermal communication with each other to facilitate heat transfer between the first working fluid and the second working fluid.

Another general aspect of the present disclosure is directed to a thermal management system. The thermal management system includes a first fluid loop for circulating a first working fluid, a second fluid loop for circulating a second working fluid, and a manifold defining a first manifold flow path and a second manifold flow path. The first manifold flow path is in fluid communication with the first fluid loop for directing the first working fluid. The second manifold flow path in fluid communication with the second fluid loop to direct the second working fluid. The second manifold flow path is not in fluid communication with the first manifold flow path. The thermal management system also includes a first heating element operatively attached to the manifold and in thermal communication with the first manifold flow path for heating the first working fluid as the first working fluid flows through the first manifold flow path. The thermal management system also includes a second heating element operatively attached to the manifold and in thermal communication with the second manifold flow path for heating the second working fluid as the second working fluid flows through the second manifold flow path. The second heating element is operable independent of the first heating element. The thermal management system also includes a heat exchanger defining a first heat exchanger flow path interposed in fluid communication between the first manifold flow path and the first fluid loop to facilitate flow of the first working fluid therebetween, and a second heat exchanger flow path interposed in fluid communication between the second manifold flow path and second fluid loop to facilitate flow of the second working fluid therebetween. The first heat exchanger flow path and the second heat exchanger flow path are disposed in thermal communication with each other to facilitate heat transfer between the first working fluid and the second working fluid.

A further general aspect of the present disclosure is directed toa method of operating a thermal management system comprising a manifold defining a first manifold flow path configured to direct a first working fluid and a second manifold flow path configured to direct a second working fluid, a first heating element operatively attached to the manifold and in thermal communication with the first manifold flow path to heat the first working fluid as the first working fluid flows through the first manifold flow path, a second heating element operatively attached to the manifold and in thermal communication with the second manifold flow path to heat the second working fluid as the second working fluid flows through the second manifold flow path, and a heat exchanger operatively attached to the manifold and defining a first heat exchanger flow path in fluid communication with the first manifold flow path, and a second heat exchanger flow path in fluid communication with the second manifold flow path, wherein the first heat exchanger flow path and the second heat exchanger flow path are disposed in thermal communication with one another to facilitate heat transfer between the first working fluid and the second working fluid The method includes circulating the first working fluid in one of a first direction and a second direction opposite the first direction through the first manifold flow path and the first heat exchanger flow path. The method also includes circulating the second working fluid in one of a third direction and a fourth direction opposite the third direction through the second manifold flow path and the second heat exchanger flow path. The method further includes operating the thermal management system in a first operating mode in response to the first working fluid circulating in the first direction and the second working fluid circulating in the third direction, and operating the thermal management system in a second operating mode in response to the first working fluid circulating in the second direction and the second working fluid circulating in the fourth direction. The step of operating the thermal management system in the first operating mode includes operating the first heating element to heat the first working fluid, directing the first working fluid heated by the first heating element from the first manifold flow path through the first heat exchanger flow path, directing the second working fluid through the second heat exchanger flow path such that the first working fluid transfers heat to the second working fluid and through the second manifold flow path, and operating the second heating element to further heat the second working fluid. The step of operating the thermal management system in the second operating mode includes operating the second heating element heats the second working fluid, directing the second working fluid heated by the second heating element from the second manifold flow path through the second heat exchanger flow path, directing the first working fluid through the first heat exchanger flow path such that the second working fluid transfers heat to the first working fluid, and through the second manifold flow path, and operating the first heating element to further heat the first working fluid.

Advantageously, based on the direction of flow of the first working fluid and/or the second working fluid, energization of the first heating element and/or the second heating element, and the heat transfer effectuated between the first working fluid and the second working fluid by the heat exchanger, the thermal management apparatus/system according to the present disclosure functions to selectively prioritize heating of one of the first working fluid and the second working fluid over the other of the first working fluid and the second working fluid.

### BRIEF DESCRIPTION OF THE DRAWINGS

Other advantages of the present disclosure will be readily appreciated, as the same becomes better understood by reference to the following detailed description when considered in connection with the accompanying drawings.

FIG. 1 is a top perspective view of one example of a thermal management apparatus according to the present disclosure.

FIG. 2 is a partially schematic exploded view of the thermal management apparatus of FIG. 1.

FIG. 3 is a top perspective view of another example of a thermal management apparatus according to the present disclosure.

FIG. 4 is a partially schematic exploded view of the thermal management apparatus of FIG. 3.

FIG. 5 is a top perspective view of yet another example of a thermal management apparatus according to the present disclosure.

FIG. 6 is a top perspective view of a manifold of the thermal management apparatus of FIG. 5.

FIG. 7 is a cross-sectional view of the manifold of FIG. 6.

FIG. 8 is a partially schematic exploded view of the thermal management apparatus of FIG. 5.

FIG. 9 is a schematic representation of a thermal management system according to the present disclosure operating in a first operational mode.

FIG. 10 is a schematic representation of the thermal management system of FIG. 9 operating in a second operational mode.

FIG. 11 is a schematic representation of one implementation of a thermal management system according to the present disclosure operating in the first operational mode.

FIG. 12 is a schematic representation of the thermal management system of FIG. 11 operating in the second operational mode.

FIG. 13 is a flowchart illustrating a method of operating a thermal management system according to the present disclosure.

FIG. 14 is a flowchart illustrating steps of operating the thermal management system in a first operating mode.

FIG. 15 is a flowchart illustrating steps of operating the thermal management system in a second operating mode.

### DETAILED DESCRIPTION

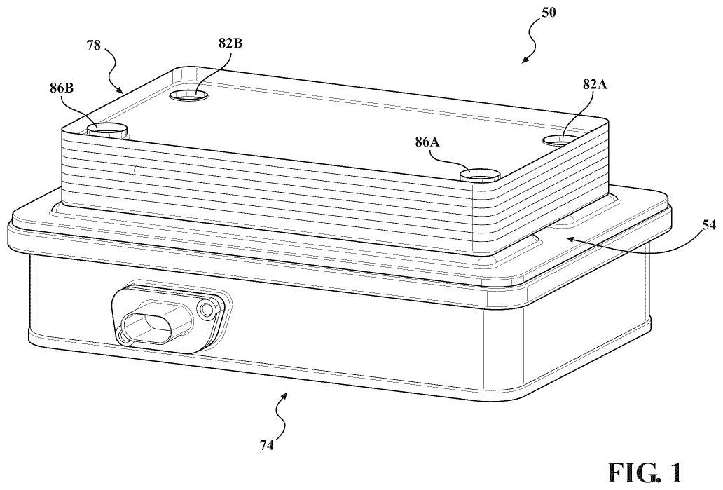

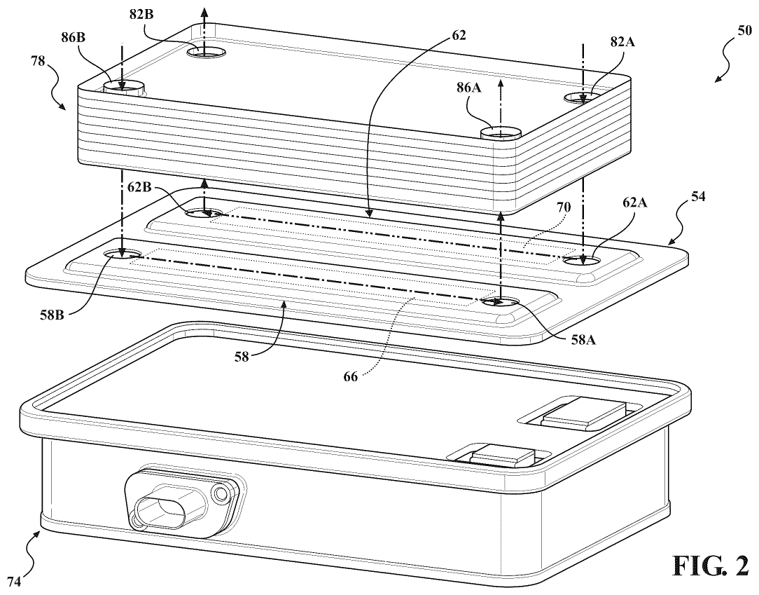

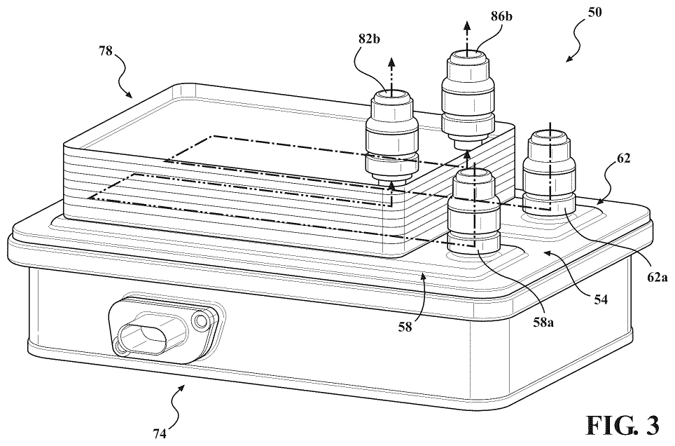

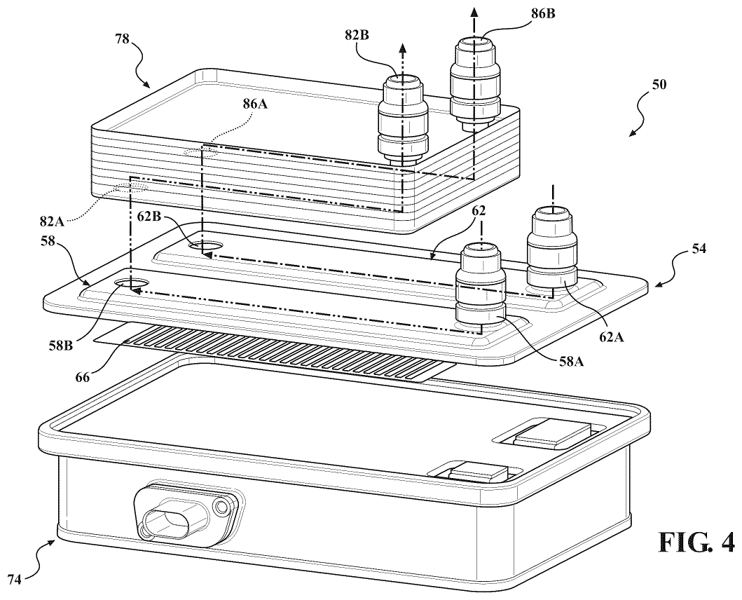

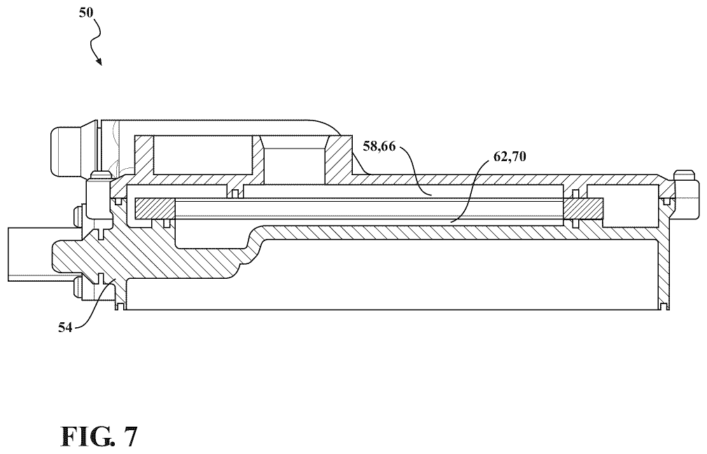

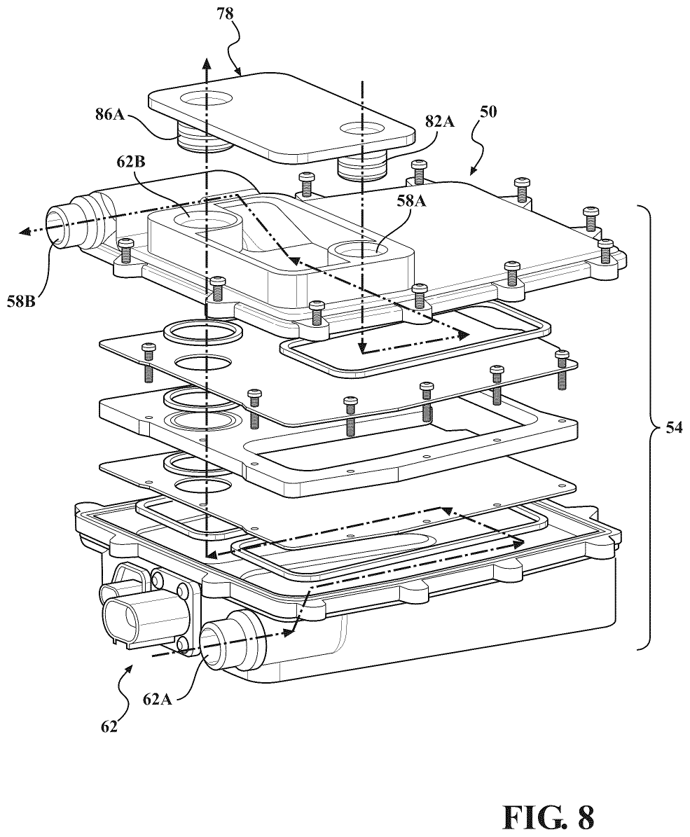

With reference to the Figures, wherein like numerals indicate like parts throughout the several views, FIGS. 1-8 generally show various examples of a thermal management apparatus 50 according to the present disclosure.

In each of the examples of FIGS. 1-8, the thermal management apparatus 50 includes a manifold 54. The manifold 54 defines a first manifold flow path 58 configured to direct a first working fluid WF1 and a second manifold flow path 62 configured to direct a second working fluid WF2.

The first manifold flow path 58 may extend between a first port 58A and a second port 58B such that the first manifold flow path 58 is configured to direct the first working fluid WF1 between the first port 58A and the second port 58B. It should be appreciated that in this context the phrase “between the first port 58A and the second port 58B” is not limited in direction. For example, the first working fluid WF1 may flow from the first port 58A to the second port 58B, or from the second port 58B to the first port 58A. The second manifold flow path 62 may extend between a third port 62A and a fourth port 62B such that the second manifold flow path 62 is configured to direct the second working fluid WF2 between the third port 62A and the fourth port 62B. Similar to above, it should be appreciated that in this context the phrase “between the third port 62A and the fourth port 62B” is not limited in direction. For example, the second working fluid WF2 may flow from the third port 62A to the fourth port 62B, or from the fourth port 62B to the third port 62A. It should also be appreciated that the second manifold flow path 62 is not in fluid communication with the first manifold flow path 58.

The composition of the first working fluid WF1 and the second working fluid WF2 is not particularly limited for the purposes of this disclosure. In some examples, the first working fluid WF1 and the second working fluid WF2 are the same composition, but in other examples, the first working fluid WF1 and the second working fluid WF2 are different compositions. The first working fluid WF1 and/or the second working fluid WF2 may be a cooling fluid suitable for a vehicular application such as water, ethylene glycol, propylene glycol, and the like. The first working fluid WF1 and/or the second working fluid WF2 may also be a refrigerant suitable for a vehicular application such as 1,1,1,2-tetrafluoroethane (also known as R-134a), 2,3,3,3-tetrafluoropropene (also known as R1234yf), and the like.

The construction of the manifold 54 is not particularly limited for the purposes of this disclosure. From a material perspective, the manifold 54 may be comprised of any suitable material that is compatible with the first working fluid WF1 and the second working fluid WF2 and the operating temperatures thereof. For example, the manifold 54 may be comprised of a metal/metal alloy (such as steel, aluminum, etc.) or a plastic/composite. The shape of the manifold 54 is likewise not particularly limited for the purposes of this disclosure. Any shape/dimensions suitable for defining the first manifold flow path 58 and the second manifold flow path 62 is contemplated. In some examples, the first manifold flow path 58 and the second manifold flow path 62 may have the same shape/dimensions, but in other configurations, the first manifold flow path 58 and the second manifold flow path 62 may have different shapes/dimensions. Exemplary configurations of the manifold 54 are described in further detail below.

With continued reference to FIGS. 1-8, the thermal management apparatus 50 also includes a first heating element 66 and a second heating element 70. The first heating element 66 is operatively attached to the manifold 54 and in thermal communication with the first manifold flow path 58. Accordingly, the first heating element 66 is configured to generate heat in response to being energized to heat the first working fluid WF1 as the first working fluid WF1 flows through the first manifold flow path 58 of the manifold 54. The second heating element 70 is operatively attached to the manifold 54 and in thermal communication with the second manifold flow path 62. Accordingly, the second heating element 70 is configured to generate heat in response to being energized to heat the second working fluid WF2 as the second working fluid flows WF2 through the second manifold flow path 62 of the manifold 54.

The first heating element 66 and the second heating element 70 are operable independently. In other words, the first heating element 66 may be energized without energizing the second heating element 70, the second heating element 70 may be energized without energizing the first heating element 66, or the first heating element 66 and the second heating element 70 may be energized simultaneously, etc. Independent operability of the first heating element 66 and the second heating element 70 permits the thermal management apparatus 50 to be capable of independently adjusting the temperature of the first working fluid WF1 and the second working fluid WF2.

The first heating element 66 and the second heating element 70 are typically electrical heating elements such as resistive heaters. The first heating element 66 and/or the second heating element 70 may be tubular/sheathed resistive heating elements, coiled resistive heating elements, screen-printed resistive heating elements, thermal spray resistive heating elements, positive-temperature-coefficient (PTC) heating elements, the like, and combinations thereof. The first heating element 66 and/or the second heating element 70 may be operable at high voltages such as voltages typically associated with electric vehicle battery architectures (e.g. 400 volts, 800 volts, etc.). The arrangement of the first heating element 66 and the second heating element 70 relative to the first manifold flow path 58 and the second manifold flow path 62, respectively, are not necessarily limited for the purposes of this disclosure. In some configurations, the first heating element 66 and/or the second heating element 70 are/is disposed within the first manifold flow path 58 and the second manifold flow path 62, respectively. In other examples, the first heating element 66 and/or the second heating element 70 are/is disposed on the manifold 54 (e.g. on a surface of the manifold 54) yet still in thermal communication with the first manifold flow path 58 and the second manifold flow path 62, respectively. Other configurations and arrangements of the first heating element 66 and the second heating element 70 are contemplated.

The thermal management apparatus 50 may also include a control module 74 in communication with the first heating element 66 and the second heating element 70 to energize the first heating element 66 and the second heating element 70 to heat the first working fluid WF1 and the second working fluid WF2, respectively. In the configurations of FIGS. 1-8, the control module 74 is coupled to or integrated within the manifold 54. In these examples, the control module 74 includes a number of connection ports for power/communication purposes (e.g. to connect the control module 74 to a wiring harness of a vehicle or a system-level controller 144, described below). However, it is contemplated that in other examples, the hardware for energizing the first heating element 66 and the second heating element 70 may be located remote from the thermal management apparatus 50 (e.g. within a separate electronic module of a vehicle).

Still referring to FIGS. 1-8, the thermal management apparatus 50 also includes a heat exchanger 78 operatively attached to the manifold 54. The heat exchanger 78 defines a first heat exchanger flow path 82 and a second heat exchanger flow path 86. The first heat exchanger flow path 82 is in fluid communication with the first manifold flow path 58 (e.g. via at least one of the first port 58A and the second port 58B) such that the first heat exchanger flow path 82 is configured to direct the first working fluid WF1 therethrough. The second heat exchanger flow path 86 is in fluid communication with the second manifold flow path 62 (e.g. via at least one of the third port 62A and the fourth port 62B) such that the second heat exchanger flow path 86 is configured to direct the second working fluid WF2 therethrough. As described in further detail below, the first manifold flow path 58 and the first heat exchanger flow path 82 are configured to direct the first working fluid WF1 in a first direction D1 and a second direction D2 opposite the first direction D1, and the second manifold flow path 62 and the second heat exchanger flow path 86 are configured to direct the second working fluid WF2 in a third direction D3 and a fourth direction D4 opposite the third direction D3.

The first heat exchanger flow path 82 and the second heat exchanger flow path 86 are disposed in thermal communication to facilitate heat transfer between the first working fluid WF1 and the second working fluid WF2. By facilitating heat transfer between the first working fluid WF1 and the second working fluid WF2, the heat exchanger 78 provides additional operative flexibility and advantages when using the thermal management apparatus 50 according to the present disclosure, which are described in further detail below. More specifically, based on the direction of flow of the first working fluid WF1 and/or the second working fluid WF2, energization of the first heating element 66 and/or the second heating element 70, and the heat transfer effectuated between the first working fluid WF1 and the second working fluid WF2 by the heat exchanger 78, the thermal management apparatus 50 functions to selectively prioritize heating of one of the first working fluid WF1 and the second working fluid WF2 over the other of the first working fluid WF1 and the second working fluid WF2.

In an example of prioritizing heating of the second working fluid WF2 over the first working fluid WF1, in response to the first working fluid WF1 flowing in the first direction D1 and the second working fluid WF2 flowing in the third direction D3, the first heating element 66 may be energized to heat the first working fluid WF1, and the first working fluid WF1 heated by the first heating element 66 flows from the first manifold flow path 58 through the first heat exchanger flow path 82, and the second working fluid WF2 flows through the second heat exchanger flow path 86 such that the first working fluid WF1 transfers heat to the second working fluid WF2, and through the second manifold flow path 62 such that the second heating element 70 further heats the second working fluid WF2. In an example of prioritizing heating of the first working fluid WF1 over the second working fluid WF2, in response to the first working fluid WF1 flowing in the second direction D2 and the second working fluid WF2 flowing in the fourth direction D4, the second heating element 70 heats the second working fluid WF2, and the second working fluid WF2 heated by the second heating element 70 flows from the second manifold flow path 62 through the second heat exchanger flow path 86, and the first working fluid WF1 flows through the first heat exchanger flow path 82 such that the second working fluid WF2 transfers heat to the first working fluid WF1, and through the first manifold flow path 58 such that the first heating element 66 further heats the first working fluid WF1.

The configuration of the heat exchanger 78 is not necessarily limited for the purposes of this disclosure. In the examples of FIGS. 1-8, the heat exchanger 78 is a plate-type heat exchanger where the first working fluid WF1 and the second working fluid WF2 exchange heat by flowing adjacent to each other between plates disposed parallel to each other (not shown in detail). However, it is also contemplated that the heat exchanger 78 may be other forms of a heat exchanger such as a tubular-type heat exchanger, a spiral-type heat exchanger, etc. Additionally, the direction of flow of the first working fluid WF1 and the second working fluid WF2 through the heat exchanger 78 is not necessarily limited for the purposes of this disclosure. In other words, the first working fluid WF1 and the second working fluid WF2 may flow in the same direction through the heat exchanger 78 (i.e., concurrent flow), or the first working fluid WF1 and the second working fluid WF2 may flow in opposite directions through the heat exchanger 78 (i.e., countercurrent flow).

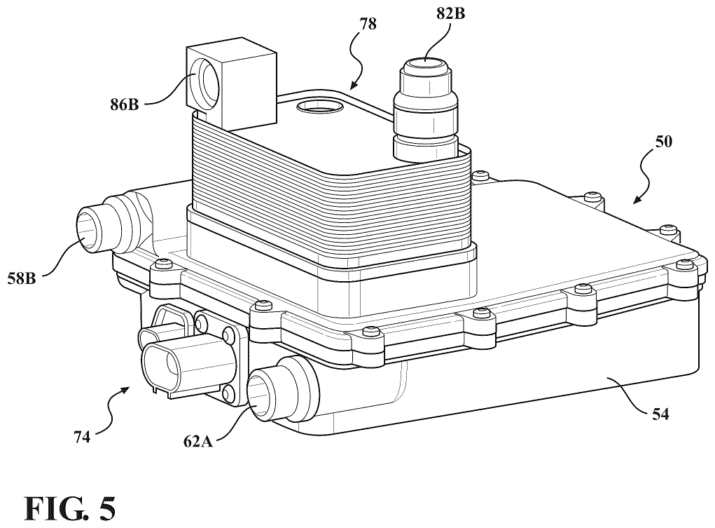

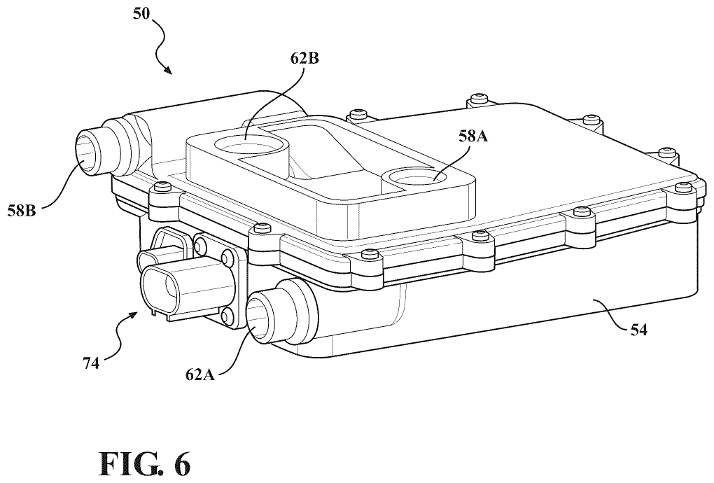

Referring to the configurations of FIGS. 1-4, in some examples, the manifold 54 is defined by a pair of stamped metallic plates which are coupled to each other to define the first manifold flow path 58 and the second manifold flow path 62. In the examples of FIGS. 1-4, the manifold 54 is comprised of aluminum plates which are brazed together and have corresponding stamped detents which cooperate to define the first manifold flow path 58 and the second manifold flow path 62. In these examples, the first heating element 66 and the second heating element 70 are coupled to an outer surface of the manifold 54 to heat the first working fluid WF1 and the second working fluid WF2, respectively. Also in the examples of FIGS. 1-4, the heat exchanger 78 is attached to one side of the manifold 54, and the control module 74 is coupled to the other side of the manifold 54 to energize the first heating element 66 and the second heating element 70 to heat the first working fluid WF1 and the second working fluid WF2, respectively. The examples of FIGS. 5-8, on the other hand, show the manifold 54, the first heating element 66 and the second heating element 70, and the control module 74 integrated into one assembly (best shown in FIGS. 6-8), wherein the heat exchanger 78 is coupled to two of the ports of the manifold 54.

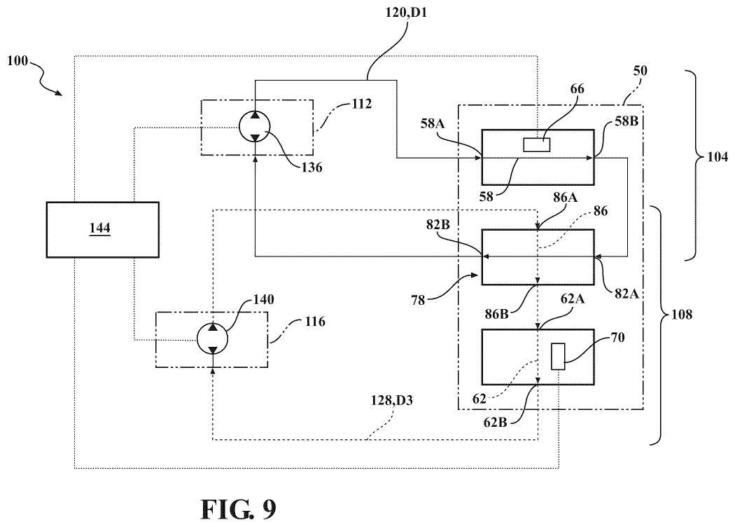

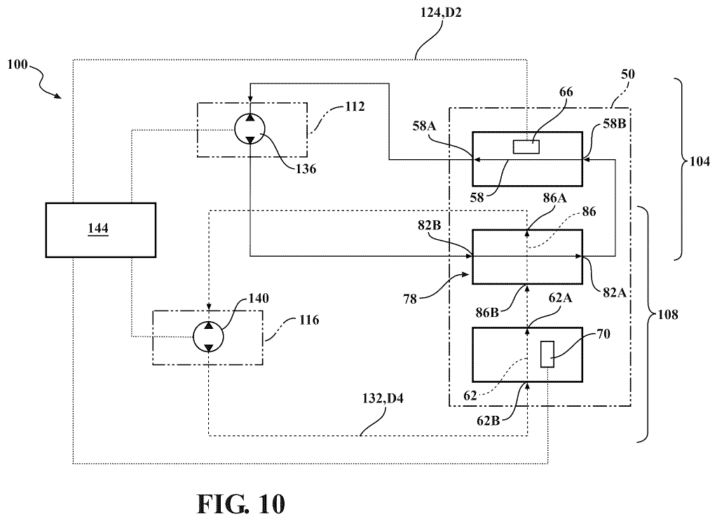

Referring to FIGS. 9 and 10, the present disclosure is also directed to a thermal management system 100 (e.g. for a hybrid or electric vehicle) including the thermal management apparatus 50 described above. The thermal management system 100 includes a first fluid loop 104 for circulating the first working fluid WF1, and a second fluid loop 108 for circulating the second working fluid WF2. The first fluid loop 104 is configured to be in fluid communication with one or more components (illustrated schematically in FIGS. 9 and 10 by phantom box 112) of a vehicle for thermal management of such component(s) 112 by the first working fluid WF1. Likewise, the second fluid loop 108 is configured to be in fluid communication with one or more components (illustrated schematically in FIGS. 9 and 10 by phantom box 116) of a vehicle for thermal management of such component(s) 116 by the second working fluid WF2. Exemplary component(s) 112, 116 include, but are not limited to, a vehicle battery, an electric motor, an inverter, power electronics, a compressor, an ambient air heat exchanger, and a cabin heat exchanger. It should be appreciated that more than one component 112, 116 may be arranged in fluid communication with the first fluid loop 104 and the second fluid loop 108, respectively. Using the first fluid loop 104 as an example, a plurality of components 112 may be arranged in series such that the first working fluid WF1 flows between the components 112 via the first fluid loop 104; however, in other examples, the first fluid loop 104 is bifurcated such that a plurality of components 112 are arranged in parallel as the first working fluid WF1 flows between the components 112 via the first fluid loop 104. Of course, the same arrangements described with respect to the first fluid loop 104 may be applicable to the second fluid loop 108. In some examples, the first working fluid WF1 is a coolant (as described above) and the first fluid loop 104 is in communication with the powertrain components (e.g., battery, motor, inverter, etc.) of a vehicle, and the second working fluid WF2 is a refrigerant (as described above) and the second fluid loop 108 is in communication with the HVAC components of (e.g., the compressor, cabin heat exchanger, etc.) of a vehicle. Other configurations of the first fluid loop 104 and the second fluid loop 108 are contemplated.

Both the first fluid loop 104 and the second fluid loop 108 are configured such that the first working fluid WF1 and the second working fluid WF2, respectively, are configured to flow in two directions. More specifically, referring to FIG. 9, the first fluid loop 104 is configured to circulate the first working fluid WF1 in a first direction D1 (schematically depicted by arrows 120), and, referring to FIG. 10, the first fluid loop 104 is also configured to circulate the first working fluid WF1 in a second direction D2 (schematically depicted by arrows 124), opposite the first direction D1. Similarly, referring to FIG. 9, the second fluid loop 108 is configured to circulate the second working fluid WF2 in a third direction D3 (schematically depicted by arrows 128), and, referring to FIG. 10, the second fluid loop 108 is also configured to circulate the second working fluid WF2 in a fourth direction D4 (schematically depicted by arrows 132), opposite the first direction D3. As will be appreciated from the subsequent description, having both the first working fluid WF1 and the second working fluid WF2 configured to flow in two directions provides additional flexibility for transferring heat within the thermal management system 100.

A variety of configurations for circulating the first working fluid WF1 about the first fluid loop 104 in both the first direction D1 and the second direction D2, as well as for circulating the second working fluid WF2 about the second fluid loop 108 in both the third direction D3 and the fourth direction D4, are contemplated. In one non-limiting example, the thermal management system 100 includes a first pump 136 in fluid communication with the first fluid loop 104 and configured to circulate the first working fluid WF1 about the first fluid loop 104 in the first direction D1 and the second direction D2, as well as a second pump 140 in fluid communication with the second fluid loop 108 and configured to circulate the second working fluid WF2 about the second fluid loop 108 in the third direction D3 and the fourth direction D4. The first pump 136 and second pump 140 may be embodied as standalone components coupled to the first fluid loop 104 and the second fluid loop 108, respectively. In other examples, such as illustrated schematically in FIGS. 9 and 10, the first pump 136 and second pump 140 are integrated within the component(s) 112, 116. The first pump 136 and/or the second pump 140 may be implemented as bidirectional pumps to achieve bidirectional flow of the first working fluid WF1 and the second working fluid WF2 about first fluid loop 104 and the second fluid loop 108, respectively. Other configurations for achieving bidirectional flow of the first working fluid WF1 and the second working fluid WF2 about first fluid loop 104 and the second fluid loop 108, respectively, may be realized through actuatable valve arrangements or other suitable componentry.

As illustrated schematically in FIGS. 9 and 10, the first manifold flow path 58 of the manifold 54 is in fluid communication with the first fluid loop 104 for directing the first working fluid WF1. In one configuration, at least one of the first port 58A and the second port 58B of the first manifold flow path 58 is in fluid communication with the first fluid loop 104 such that the first manifold flow path 58 directs the first working fluid WF1 between the first port 58A and the second port 58B, but other configurations are contemplated. As also illustrated schematically in FIGS. 9 and 10, the second manifold flow path 62 of the manifold 54 is in fluid communication with the second fluid loop 108 to direct the second working fluid WF2. In one configuration, at least one of the third port 62A and the fourth port 62B is in fluid communication with the second fluid loop 108 such that the second manifold flow path 62 directs the second working fluid WF2 between the third port 62A and the fourth port 62B, but other configurations are contemplated. As described above and illustrated schematically in FIGS. 9 and 10, the first heating element 66 is operatively attached to the manifold 54 and in thermal communication with the first manifold flow path 58 for heating the first working fluid WF1 as the first working fluid WF1 flows through the first manifold flow path 58, and the second heating element 70 is operatively attached to the manifold 54 and in thermal communication with the second manifold flow path 62 for heating the second working fluid WF2 as the second working fluid WF2 flows through the second manifold flow path 62.

As illustrated schematically in FIGS. 9 and 10, the first heat exchanger flow path 82 of the heat exchanger 78 is interposed in fluid communication between the first manifold flow path 58 of the manifold 54 and the first fluid loop 108 to facilitate flow of the first working fluid WF1 therebetween. In one configuration, the first heat exchanger flow path 82 extends between a first orifice 82A and a second orifice 82B such that the first heat exchanger flow path 82 directs the first working fluid WF1 between the first orifice 82A and the second orifice 82B. Here, the first orifice 82A is in fluid communication with the other of the first port 58A and the second port 58B of the manifold 54, and the second orifice 82B in fluid communication with the first fluid loop 108, but other configurations are contemplated. With continued reference to FIGS. 9 and 10, the second heat exchanger flow path 86 is interposed in fluid communication between the second manifold flow path 62 of the manifold 54 and the second fluid loop 108 to facilitate flow of the second working fluid WF2 therebetween. In one configuration, the second heat exchanger flow path 86 extends between a third orifice 86A and a fourth orifice 86B such that the second heat exchanger flow path 86 directs the second working fluid WF2 between the third orifice 86A and the fourth orifice 86B. Here, the third orifice 86A is in fluid communication with the other of the third port 62A and the fourth port 62B of the manifold 54, and the fourth orifice 86B in fluid communication with the second fluid loop 108, but other configurations are contemplated. As described above and illustrated schematically in FIGS. 9 and 10, the first heat exchanger flow path 82 and the second heat exchanger flow path 86 are disposed in thermal communication to facilitate heat transfer between the first working fluid WF1 and the second working fluid WF2.

With continued reference to FIGS. 9 and 10, the thermal management system 100 further includes a controller 144. The controller 144 is in communication with the first heating element 66 to selectively energize the first heating element 66 to heat the first working fluid WF1 within the first manifold flow path 58, and the second heating element 70 to selectively energize the second heating element 70 to heat the second working fluid WF2 within the second manifold flow path 62. The controller 144 is configured to operate the thermal management system 100 between a plurality of modes including but not limited to a first operational mode (illustrated in FIG. 9 and described below) and a second operational mode (illustrated in FIG. 10 and described below). In some examples, such as illustrated schematically in FIGS. 9 and 10, the controller 144 is also in communication with the first fluid loop 104 to control the direction of the first working fluid WF1 (e.g. via the first pump 136) and/or the second fluid loop 108 to control the direction of the second working fluid WF2 (e.g. via the second pump 140). However, it should be appreciated that in other configurations the direction of the first working fluid WF1 and/or the direction of the second working fluid WF2 may be controlled by another system of the vehicle, and the controller 144 of the thermal management system 100 may select the operational mode of the thermal management system 100 in response to the direction of the first working fluid WF1 and/or the direction of the second working fluid WF2. In other words, in some examples, the controller 144 does not control the direction of the first working fluid WF1 and/or the direction of the second working fluid WF2 but instead operates the thermal management system 100 based on the direction of the first working fluid WF1 and/or the direction of the second working fluid WF2.

With reference to FIG. 9, where the controller 144 operates the thermal management system 100 in the first operational mode, the controller 144 operates the first heating element 66 to heat the first working fluid WF1 while the first pump 136 circulates the first working fluid WF1 in the first direction D1 such that the first working fluid WF1 heated by the first heating element 66 flows from the first manifold flow path 58 of the manifold 54 through the first heat exchanger flow path 82 of the heat exchanger 78 and to the first fluid loop 104. In some configurations, such as illustrated schematically in FIG. 9, the controller 144 operates the first pump 136 to circulate the first working fluid WF1 in the first direction D1 such that the first working fluid WF1 heated by the first heating element 66 flows from the first manifold flow path 58 of the manifold 54 through the first orifice 82A of the heat exchanger 78, through the first heat exchanger flow path 82 to the second orifice 82B, and through the second orifice 82B to the first fluid loop 104, but other configurations are contemplated.

Meanwhile, with continued reference to FIG. 9, where the controller 144 operates the thermal management system 100 in the first operational mode, the controller 144 operates the second pump 140 to circulate the second working fluid WF2 in the third direction D3 such that the second working fluid WF2 flows from the second fluid loop 108 through the second heat exchanger flow path 86 of the heat exchanger 78 such that the first working fluid WF1 transfers heat to the second working fluid WF2, and through the second manifold flow path 62 of the manifold 54 such that the second heating element 70 further heats the second working fluid WF2. In some configurations, such as illustrated schematically in FIG. 9, the controller 144 operates the second pump 140 to circulate the second working fluid WF2 in the third direction D3 such that the second working fluid WF2 flows from the fourth orifice 86B of the heat exchanger 78 and through the second heat exchanger flow path 86 such that the first working fluid WF1 transfers heat to the second working fluid WF2, and through the third orifice 86A to the second manifold flow path 62 of the manifold 54 such that the second heating element 70 further heats the second working fluid WF2, but other configurations are contemplated.

In any event, where the controller 144 operates the thermal management system 100 in the first operational mode, the first heating element 66 heats the first working fluid WF1, which then flows through the heat exchanger 78 and heats the second working fluid WF2, which is then subsequently further heated by the second heating element 70. Thus, in effect, the second working fluid WF2 receives the benefit of being heated (directly or indirectly) by both the first heating element 66 and the second heating element 70.

With reference to FIG. 10, where the controller 144 operates the thermal management system 100 in the second operational mode, the controller 144 operates the second heating element 70 to heat the second working fluid WF2 while the second pump 140 circulates the second working fluid WF2 in the fourth direction D4 such that the second working fluid WF2 heated by the second heating element 70 flows from the second manifold flow path 62 of the manifold 54 through the second heat exchanger flow path 86 of the heat exchanger 78, and to the second fluid loop 108. In some configurations, such as illustrated schematically in FIG. 10, the controller 144 operates the second pump 140 to circulate the second working fluid WF2 in the fourth direction D4 such that the second working fluid WF2 heated by the second heating element 70 flows from the second manifold flow path 62 of the manifold 54 to the third orifice 86A of the heat exchanger 78, through the second heat exchanger flow path 86 to the fourth orifice 86B, and through the fourth orifice 86B to the second fluid loop 108, but other configurations are contemplated.

Meanwhile, with continued reference to FIG. 10, where the controller 144 operates the thermal management system 100 in the second operational mode, the controller 144 operate the first pump 136 to circulate the first working fluid WF1 in the second direction D2 such that the first working fluid WF1 flows from the first fluid loop 104 through the first heat exchanger flow path 82 of the heat exchanger 78 such that the second working fluid WF2 transfers heat to the first working fluid WF1, and through the second manifold flow path 62 of the manifold 54 such that the first heating element 66 further heats the first working fluid WF1. In some configurations, such as illustrated schematically in FIG. 10, the controller 144 operates the first pump 136 to circulate the first working fluid WF1 in the second direction D2 such that the first working fluid WF1 flows from the second orifice 82B of the heat exchanger 78 and through the first heat exchanger flow path 82 such that the second working fluid WF2 transfers heat to the first working fluid WF1, and through the first orifice 82A to the first manifold flow path 58 of the manifold 54 such that the first heating element 66 further heats the first working fluid WF1.

In any event, in contrast to the first operational mode described above, where the controller 144 operates the thermal management system 100 in the second operational mode, the second heating element 70 heats the second working fluid WF2, which then flows through the heat exchanger 78 to heat the first working fluid WF1, which is then further heated by the first heating element 66. Thus, in effect, the first working fluid WF1 receives the benefit of being heated (directly or indirectly) by both the first heating element 66 and the second heating element 70.

It should be appreciated in view of the present disclosure that the thermal management apparatus 50 disclosed herein has particular operational advantages when employed in a thermal management system 100 for a hybrid or electric vehicle. Particularly, by including the first heating element 66 and the second heating element 70 that are operable independently from one another, and the adjacently arranged heat exchanger 78 for exchanging heat between the first working fluid WF′1 and the second working fluid WF2, a number of advantages are realized including increased operational flexibility, reduced packaging footprint, etc. It should also be appreciated that additional operational modes of the thermal management system 100 are contemplated. More specifically, any operational direction of circulation of first working fluid WF1 about the first fluid loop 104, any operational direction of circulation of second working fluid WF2 about the second fluid loop 108, and any energization of the first heating element and/or the second heating element are contemplated.

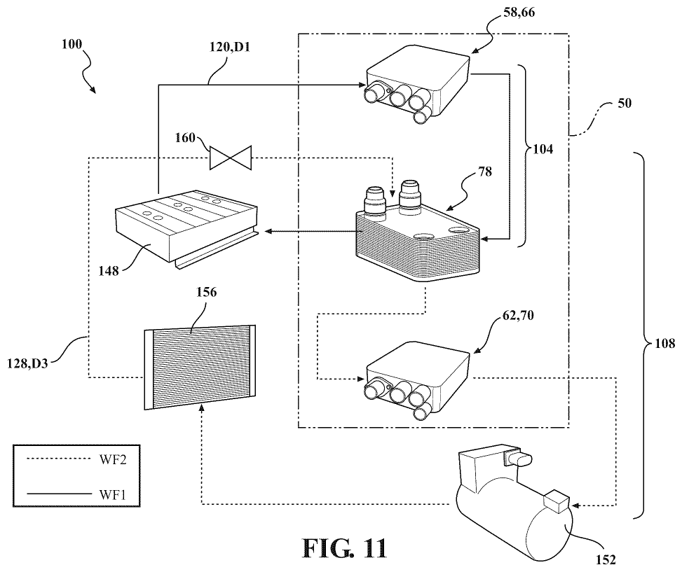

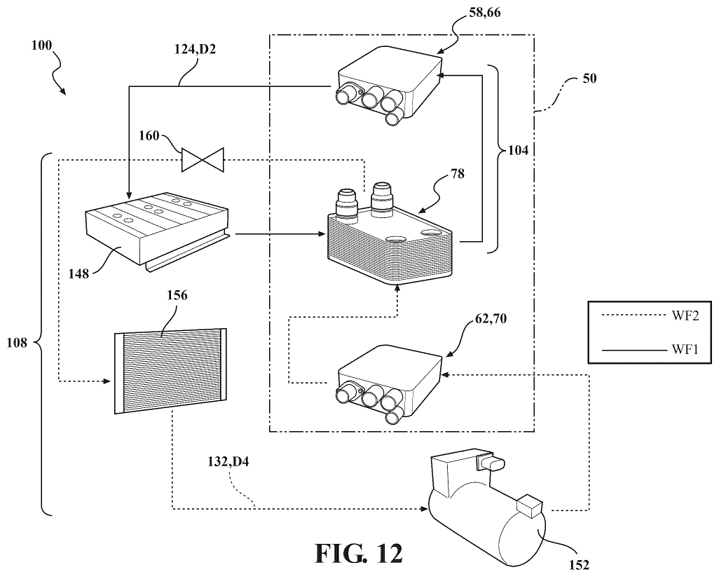

FIGS. 11 and 12 provide a schematic example of one implementation of the thermal management system 100 operating in the first operational mode (shown in FIG. 11) and the second operational mode (shown in FIG. 12). In both FIGS. 11 and 12, the component(s) 112 in fluid communication with the first fluid loop 104 include at least a vehicle battery 148, and the component(s) 116 in fluid communication with the second fluid loop include a compressor 152, a vehicle cabin heat exchanger 156, and an expansion valve 160 arranged in series relative to each other. Of course, it should be appreciated that other components 116 may be in communication with the first fluid loop 104.

Referring first to FIG. 11, the controller 144 (not shown in FIG. 11) may be configured to operate the thermal management system 100 in the first operational mode in response to a scenario where the vehicle cabin heat exchanger 156 has a high heat demand. Here, there are at least three potential sources of heat for the vehicle cabin heat exchanger 156—namely, the first heating element 66, the second heating element 70, and the compressor 152. Accordingly, as described above in the context of FIG. 9, the controller 144 may be configured to operate the thermal management system 100 in the first operational mode such that the first heating element 66 heats the first working fluid WF1, which then flows through the heat exchanger 78 to heat the second working fluid WF2, which is then subsequently further heated by the second heating element 70 and finally provided to the cabin heat exchanger 156. Again, in effect, the second working fluid WF2 receives the benefit of being heated (directly or indirectly) by both the first heating element 66 and the second heating element 70, thereby allowing more heat to be provided to the cabin heat exchanger 156 than otherwise possible without utilizing higher capacity heating elements for the first and second fluid loops 104, 108.

Referring next to FIG. 12, the controller 144 (not shown in FIG. 12) may be configured to operate the thermal management system 100 in the second operational mode in response to a scenario where the vehicle battery 148 has a high heat demand (e.g. where the vehicle battery is being pre-conditioned to receive a fast charge). Here, there are at least three potential sources of heat for the vehicle battery 148—namely, the first heating element 66, the second heating element 70, and the compressor 152. Accordingly, similar to as described above in the context of FIG. 10, the controller 144 may be configured to operate the thermal management system 100 in the second operational mode such that the second heating element 70 heats the second working fluid WF2, which then flows through the heat exchanger 78 to heat the first working fluid WF1, which is then subsequently further heated by the first heating element 66 and finally provided to the vehicle battery 148. Again, in effect, the first working fluid WF1 receives the benefit of being heated (directly or indirectly) by both the first heating element 66 and the second heating element 70, thereby allowing more heat to be provided to the vehicle battery 148 than otherwise possible without utilizing higher capacity heating elements for the first and second fluid loops.

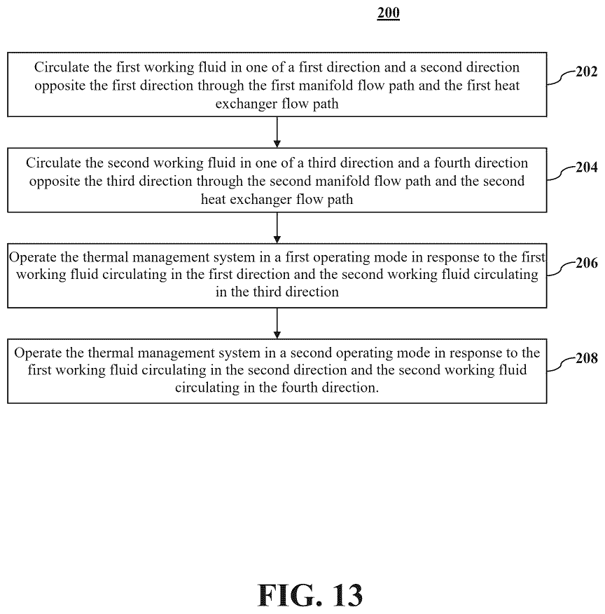

The present disclosure is also directed to a method 200 of operating the thermal management system 100. Referring to FIGS. 13, the method 200 generally includes a step 202 of circulating the first working fluid WF1 in one of a first direction D1 and a second direction D2 opposite the first direction D1 through the first manifold flow path 58 and the first heat exchanger flow path 82. The method 200 also includes a step 204 of circulating the second working fluid WF2 in one of a third direction D3 and a fourth direction D4 opposite the third direction D3 through the second manifold flow path 62 and the second heat exchanger flow path 86. The method 200 further includes a step 206 of operating the thermal management system 100 in a first operating mode in response to the first working fluid WF1 circulating in the first direction D1 and the second working fluid WF2 circulating in the third direction D3, and a step 208 of operating the thermal management system 100 in a second operating mode in response to the first working fluid WF1 circulating in the second direction D2 and the second working fluid WF2 circulating in the fourth direction D4.

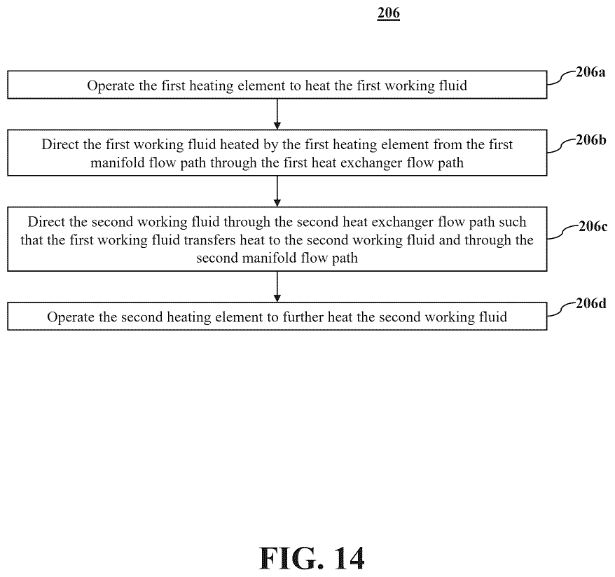

Referring to FIG. 14, the step 206 of operating the thermal management system 100 in the first operating mode includes a sub-step 206a of operating the first heating element 66 to heat the first working fluid WF1, a sub-step 206b of directing the first working fluid WF1 heated by the first heating element 66 from the first manifold flow path 58 through the first heat exchanger flow path 82, a sub-step 206c of directing the second working fluid WF2 through the second heat exchanger flow path 86 such that the first working fluid WF1 transfers heat to the second working fluid WF2 and through the second manifold flow path 62, and a sub-step 206d of operating the second heating element 70 to further heat the second working fluid WF2. Here, operation of the thermal management system 100 in the first operating mode according to step 206 of the method 200 prioritizes heating of the second working fluid WF2 over the first working fluid WF1.

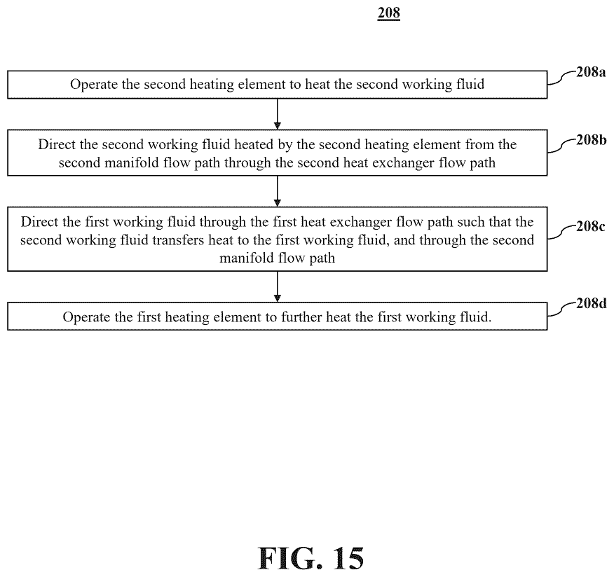

Referring to FIG. 15, the step 208 of operating the thermal management system 100 in the second operating mode includes a sub-step 208a of operating the second heating element 70 to heat the second working fluid WF2, a sub-step 208b of directing the second working fluid WF2 heated by the second heating element 70 from the second manifold flow path 62 through the second heat exchanger flow path 86, a sub-step 208c of directing the first working fluid WF1 through the first heat exchanger flow path 82 such that the second working fluid WF2 transfers heat to the first working fluid WF1, and through the second manifold flow path 62, and operating the first heating element 66 to further heat the first working fluid WF1. Here, operation of the thermal management system 100 in the second operating mode according to step 208 of the method 200 prioritizes heating of the first working fluid WF1 over the second working fluid WF2.

It should also be appreciated that the method 200 may include operating the thermal management system 100 in additional operational modes. More specifically, any operational direction of circulation of first working fluid WF1 about the first fluid loop 104, any operational direction of circulation of second working fluid WF2 about the second fluid loop 108, and any energization of the first heating element and/or the second heating element are contemplated.

The invention has been described in an illustrative manner, and it is to be understood that the terminology which has been used is intended to be in the nature of words of description rather than of limitation. Many modifications and variations of the present invention are possible in light of the above teachings, and the invention may be practiced otherwise than as specifically described.

What is claimed is:

1. A thermal management apparatus comprising:
a manifold defining:
a first manifold flow path configured to direct a first working fluid, and
a second manifold flow path configured to direct a second working fluid, wherein said second manifold flow path is not in fluid communication with said first manifold flow path;
a first heating element operatively attached to said manifold and in thermal communication with said first manifold flow path, wherein said first heating element is configured to generate heat in response to being energized to heat the first working fluid as the first working fluid flows through said first manifold flow path;
a second heating element operatively attached to said manifold and in thermal communication with said second manifold flow path, wherein said second heating element is configured to generate heat in response to being energized to heat the second working fluid as the second working fluid flows through said second manifold flow path, and wherein said second heating element is operable independent of said first heating element; and
a heat exchanger operatively attached to said manifold and defining:
a first heat exchanger flow path in fluid communication with said first manifold flow path, and
a second heat exchanger flow path in fluid communication with said second manifold flow path, wherein said first heat exchanger flow path and said second heat exchanger flow path are disposed in thermal communication with each other to facilitate heat transfer between the first working fluid and the second working fluid.

2. The thermal management apparatus according to claim 1,
wherein said first manifold flow path and said first heat exchanger flow path are configured to direct the first working fluid in a first direction and a second direction opposite said first direction; and
wherein said second manifold flow path and said second heat exchanger flow path are configured to direct the second working fluid in a third direction and a fourth direction opposite said third direction.

3. The thermal management apparatus according to claim 2, wherein, in response to the first working fluid flowing in said first direction and the second working fluid flowing in said third direction, said first heating element heats the first working fluid, and the first working fluid heated by said first heating element flows from said first manifold flow path through said first heat exchanger flow path, and the second working fluid flows through said second heat exchanger flow path such that the first working fluid transfers heat to the second working fluid, and through said second manifold flow path such that said second heating element further heats the second working fluid.

4. The thermal management apparatus according to claim 2, wherein in response to the first working fluid flowing in the second direction and the second working fluid flowing in the fourth direction, said second heating element heats the second working fluid, and the second working fluid heated by said second heating element flows from said second manifold flow path through said second heat exchanger flow path, and the first working fluid flows through said first heat exchanger flow path such that the second working fluid transfers heat to the first working fluid, and through said first manifold flow path such that said first heating element further heats the first working fluid.

5. The thermal management apparatus according to claim 1, further comprising a control module in communication with said first heating element and said second heating element and configured to energize said first heating element to heat the first working fluid and said second heating element to heat the second working fluid.

6. The thermal management apparatus according to claim 1, wherein said manifold comprises a pair of stamped metallic plates which are coupled to each other to define said first manifold flow path and said second manifold flow path.

7. The thermal management apparatus according to claim 6, wherein said pair of stamped metallic plates comprise aluminum and are brazed together.

8. The thermal management apparatus according to claim 1, wherein said first heating element and said second heating element are coupled to an outer surface of said manifold.

9. The thermal management apparatus according to claim 1, wherein said first heating element is disposed in said first manifold flow path and said second heating element is disposed in said second manifold flow path.

10. Athermal management system comprising:
a first fluid loop for circulating a first working fluid;
a second fluid loop for circulating a second working fluid;
a manifold defining:
a first manifold flow path in fluid communication with said first fluid loop for directing the first working fluid, and
a second manifold flow path in fluid communication with said second fluid loop to direct the second working fluid, wherein said second manifold flow path is not in fluid communication with said first manifold flow path;
a first heating element operatively attached to said manifold and in thermal communication with said first manifold flow path for heating the first working fluid as the first working fluid flows through said first manifold flow path;
a second heating element operatively attached to said manifold and in thermal communication with said second manifold flow path for heating the second working fluid as the second working fluid flows through said second manifold flow path, wherein said second heating element is operable independent of said first heating element; and
a heat exchanger defining:
a first heat exchanger flow path interposed in fluid communication between said first manifold flow path and said first fluid loop to facilitate flow of the first working fluid therebetween, and
a second heat exchanger flow path interposed in fluid communication between said second manifold flow path and second fluid loop to facilitate flow of the second working fluid therebetween, wherein said first heat exchanger flow path and said second heat exchanger flow path are disposed in thermal communication with each other to facilitate heat transfer between the first working fluid and the second working fluid.

11. The thermal management system according to claim 10 further comprising:
a first pump in fluid communication with said first fluid loop and configured to circulate the first working fluid about said first fluid loop in a first direction and a second direction opposite said first direction;
a second pump in fluid communication with said second fluid loop and configured to circulate the second working fluid about said second fluid loop in a third direction and a fourth direction opposite said third direction; and
a controller in communication with said first pump, said second pump, said first heating element, and said second heating element, with said controller configured to operate said thermal management system between a plurality of operational modes.

12. The thermal management system according to claim 11, wherein said plurality of operational modes includes a first operational mode wherein said controller:
operates said first heating element to heat the first working fluid,
operates said first pump to circulate the first working fluid in said first direction such that the first working fluid heated by said first heating element flows from said first manifold flow path through said first heat exchanger flow path, and to said first fluid loop,
operates said second pump to circulate the second working fluid in said third direction such that the second working fluid flows from said second fluid loop through said second heat exchanger flow path such that the first working fluid transfers heat to the second working fluid, and through said second manifold flow path, and
operates said second heating element to further heat the second working fluid.

13. The thermal management system according to claim 11, wherein said plurality of operational modes includes a second operational mode wherein said controller:
operates said second heating element to heat the second working fluid,
operates said second pump to circulate the second working fluid in said fourth direction such that the second working fluid heated by said second heating element flows from said second manifold flow path through said second heat exchanger flow path, and to said second fluid loop,
operates said the first pump to circulate the first working fluid in said second direction such that the first working fluid flows from said first fluid loop through said first heat exchanger flow path such that the second working fluid transfers heat to the first working fluid, and through said second manifold flow path, and
operates said first heating element to further heat the first working fluid.

14. The thermal management system according to claim 10,
wherein said first manifold flow path extends between a first port and a second port, with one of said first port and said second port in fluid communication with said first fluid loop such that said first manifold flow path directs the first working fluid between said first port and said second port; and
wherein said first heat exchanger flow path extends between a first orifice and a second orifice, with said first orifice in fluid communication with the other of said first port and said second port, and said second orifice in fluid communication with said first fluid loop such that said first heat exchanger flow path directs the first working fluid between said first orifice and said second orifice.

15. The thermal management system according to claim 10,
wherein said second manifold flow path extends between a third port and a fourth port, with one of said third port and said fourth port in fluid communication with said second fluid loop such that said second manifold flow path directs the second working fluid between said third port and said fourth port; and
wherein said second heat exchanger flow path extends between a third orifice and a fourth orifice, with said third orifice in fluid communication with the other of said third port and said fourth port, and said fourth orifice in fluid communication with said second fluid loop such that said second heat exchanger flow path directs the second working fluid between said third orifice and said fourth orifice.

16. A method of operating a thermal management system comprising a manifold defining a first manifold flow path configured to direct a first working fluid and a second manifold flow path configured to direct a second working fluid, a first heating element operatively attached to the manifold and in thermal communication with the first manifold flow path to heat the first working fluid as the first working fluid flows through the first manifold flow path, a second heating element operatively attached to the manifold and in thermal communication with the second manifold flow path to heat the second working fluid as the second working fluid flows through the second manifold flow path, and a heat exchanger operatively attached to the manifold and defining a first heat exchanger flow path in fluid communication with the first manifold flow path, and a second heat exchanger flow path in fluid communication with the second manifold flow path, wherein the first heat exchanger flow path and the second heat exchanger flow path are disposed in thermal communication with one another to facilitate heat transfer between the first working fluid and the second working fluid, said method comprising:
circulating the first working fluid in one of a first direction and a second direction opposite the first direction through the first manifold flow path and the first heat exchanger flow path;
circulating the second working fluid in one of a third direction and a fourth direction opposite the third direction through the second manifold flow path and the second heat exchanger flow path;
operating the thermal management system in a first operating mode in response to the first working fluid circulating in the first direction and the second working fluid circulating in the third direction;
operating the thermal management system in a second operating mode in response to the first working fluid circulating in the second direction and the second working fluid circulating in the fourth direction;
wherein said step of operating the thermal management system in the first operating mode comprises:
operating the first heating element to heat the first working fluid;
directing the first working fluid heated by the first heating element from the first manifold flow path through the first heat exchanger flow path;
directing the second working fluid through the second heat exchanger flow path such that the first working fluid transfers heat to the second working fluid and through the second manifold flow path; and
operating the second heating element to further heat the second working fluid; and
wherein said step of operating the thermal management system in the second operating mode comprises:
operating the second heating element to heat the second working fluid;
directing the second working fluid heated by the second heating element from the second manifold flow path through the second heat exchanger flow path;
directing the first working fluid through the first heat exchanger flow path such that the second working fluid transfers heat to the first working fluid, and through the second manifold flow path; and
operating the first heating element to further heat the first working fluid.

17. The method of operating a thermal management system according to claim 16, wherein the thermal management system further comprises a first pump, and said step of circulating the first working fluid in one of a first direction and a second direction opposite the first direction through the first manifold flow path and the first heat exchanger flow path comprises operating the first pump to circulate the first working fluid in one of the first direction and the second direction.

18. The method of operating a thermal management system according to claim 16, wherein the thermal management system further comprises a second pump, and said step of circulating the second working fluid in one of a third direction and a fourth direction opposite the third direction through the second manifold flow path and the second heat exchanger flow path further comprises operating the second pump to circulate the second working fluid in one of the third direction and the fourth direction.
